(19) United States
(12) Patent Application Publication
(10) Pub. No.: US 2015/0138311 A1
(43) Pub. Date: May 21, 2015

(54) 360-DEGREE PANORAMIC CAMERA SYSTEMS

(71) Applicant: Panavision International, L.P., Woodland Hills, CA (US)

(72) Inventor: Clive TOWNDROW, West Hills, CA (US)

(73) Assignee: Panavision International, L.P., Woodland Hills, CA (US)

(21) Appl. No.: 14/541,962

(22) Filed: Nov. 14, 2014

Related U.S. Application Data
(60) Provisional application No. 61/907,175, filed on Nov. 21, 2013.

(51) Int. Cl. H04N 5/232; H04N 5/225

(52) U.S. Cl. CPC H04N 5/23238; H04N 5/2252
USPC 348/36

(57) ABSTRACT

360-degree panoramic camera systems include a plurality of modular cameras positioned at angular intervals to capture images around a 360-degree field of view, a camera-housing module configured to at least house the plurality of cameras, an electronic interface coupled to each camera, and an imaging system coupled to the electronic interface. The camera systems utilize technology that processes fixed images or raw video streams at a minimum of 24 frames per second. In so doing, these systems produce a high-resolution, seamless image of objects within the 360-degree field of view. The technology also allows for real-time correction of distortions, spherical projection, stitching, blending, white balance, etc.

### CROSS-REFERENCE TO RELATED APPLICATION

This application claims priority to U.S. patent application Ser. No. 61/904,175 filed Nov. 21, 2013, the entirety of which is incorporated herein by reference.

### BACKGROUND

The present disclosure relates to panoramic camera systems that provide images around a field of view, generally ranging from 180°to 360°.

As the threat of terrorism continues to pervade societies throughout the world, the need for 360-degree panoramic camera systems used for situational awareness has come to the forefront. Situational awareness, according to one definition, is the ability to identify, process, and understand critical elements of an environment in real-time. Situational awareness is not only necessary in military situations. Today, because of the pervasive threat of terrorism, amongst other potential threats, situational awareness is important even when implementing everyday security measures.

Various attempts have been made to develop 360-degree panoramic camera systems that identify and process elements of an environment in real-time. Unfortunately, many of these attempts have developed systems which do not operate in real-time (i.e. where imaging is equal to or greater than 24 frames a second). Some of these systems require complicated set-ups and operation, which include extensive routing of cables and dependency upon operator expertise in assessing security threats. Other attempts have developed systems that are unable to provide high resolution images, which are critical when analyzing different situations and assessing potential security breaches. Many of these attempts require strategic placement of multiple low resolution cameras and operator analysis of objects within captured scenes.

For these reasons, among others, there is a clear and defined need for improved 360-degree panoramic camera systems. The present invention fulfills this need and provides further related advantages, as described below.

### BRIEF SUMMARY

The panoramic camera systems disclosed herein include a plurality of modular cameras positioned at angular intervals to capture images around a 360-degree field of view, a camera housing module that houses the plurality of modular cameras, an electronic interface coupled to each camera, and an imaging system coupled to the electronic interface. Such camera systems utilize technology that processes fixed images or raw video streams at a minimum of 24 frames per second. In so doing, these systems produce high-resolution, seamless images of objects within the 360-degree field of view. The technology also allows for real-time correction of distortions, spherical projection, stitching, blending, white balance, etc.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. Moreover, the drawings described herein are for illustrative purposes only and not intended to limit the scope of the present disclosure.

FIG. 1A schematically shows one configuration of a 360-degree panoramic camera system.

FIG. 1B schematically shows one arrangement of a plurality of camera modules.

FIG. 2 illustrates the relationship of fiber attenuation to wavelength.

FIG. 3 shows a side view of one configuration of a camera module.

FIGS. 4 and 5 show perspective views of a 360-degree panoramic camera system, including a camera-housing module, an electronic interface, a plurality of camera-module receivers, and a plurality of camera modules incorporated therein.

FIG. 6 shows a partially exploded perspective view of the 360-degree panoramic camera system shown in FIG. 4.

FIG. 7 shows another partially exploded perspective view of a 360-degree panoramic camera system.

FIG. 8A shows a top cross-sectional view of a 360-degree panoramic camera system.

FIG. 8B shows a partially exploded top cross-sectional view of the 360-degree panoramic camera system shown in FIG. 8A.

FIG. 9 illustrates exemplary steps of image display.

FIG. 10 is one configuration of an output interface/display used in a 360-degree panoramic camera system.

FIG. 11 is a schematic of an imaging system configuration.

FIG. 12 schematically depicts image processing algorithms for a 360-degree panoramic camera system.

FIG. 13 shows a front view of a plurality of 360-degree modules of various wave bands on a single mast.

FIG. 14 shows an embodiment of a security imaging system incorporating elements of panoramic camera systems disclosed herein.

### DETAILED DESCRIPTION

Certain terminology is used in the following description for convenience only and is not limiting. For example, words such as “lower,” “bottom,” “upper” and “top” generally designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import.

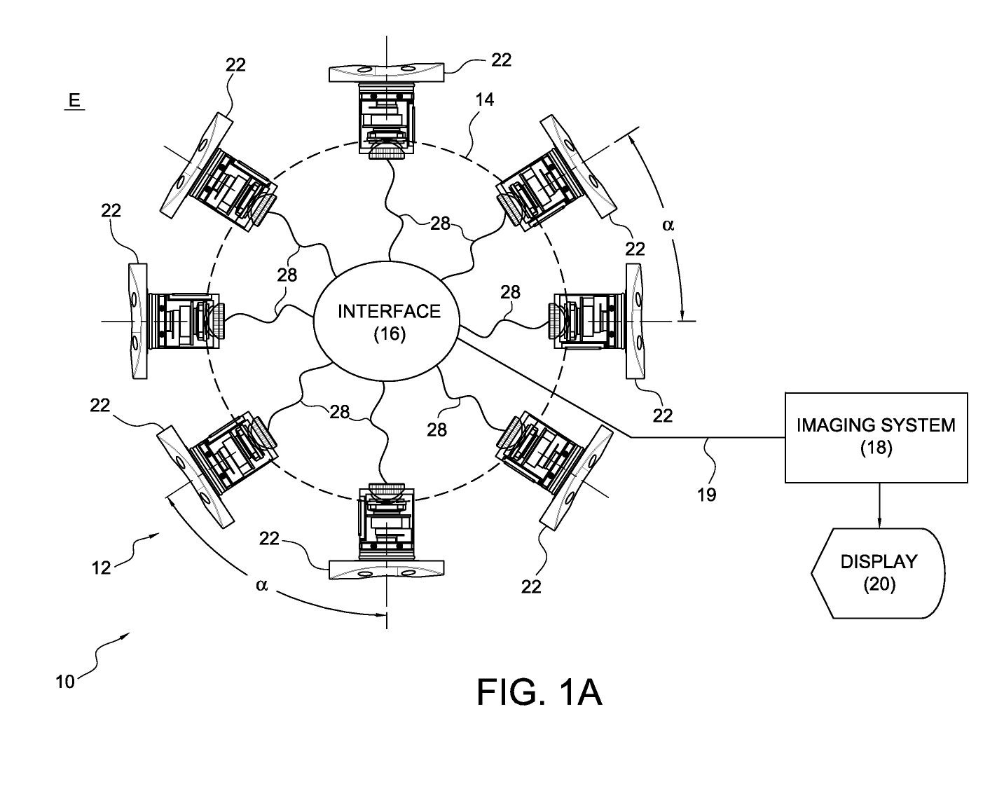

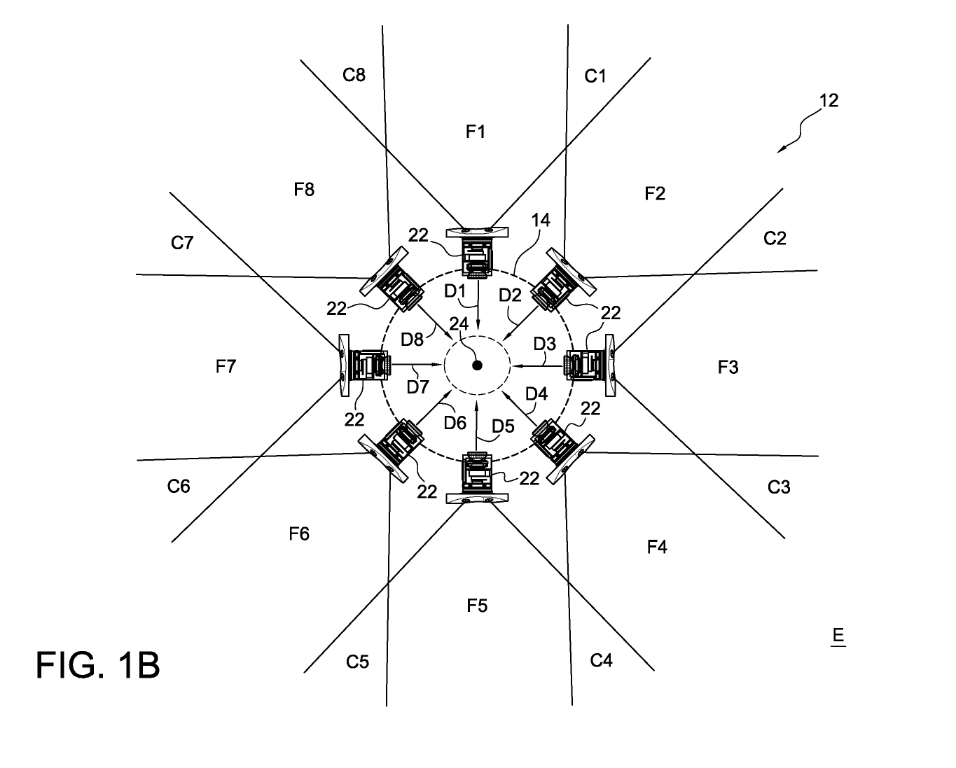

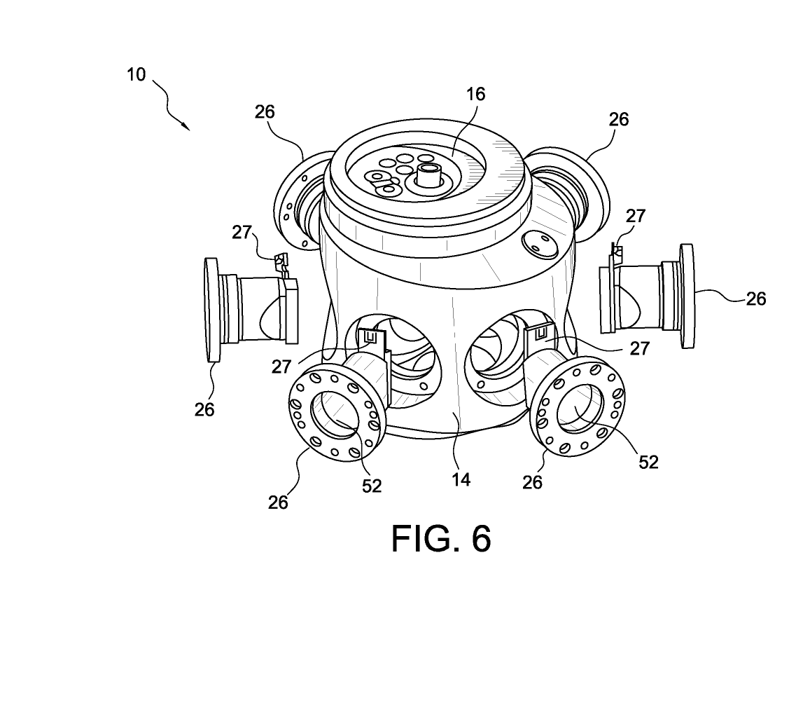

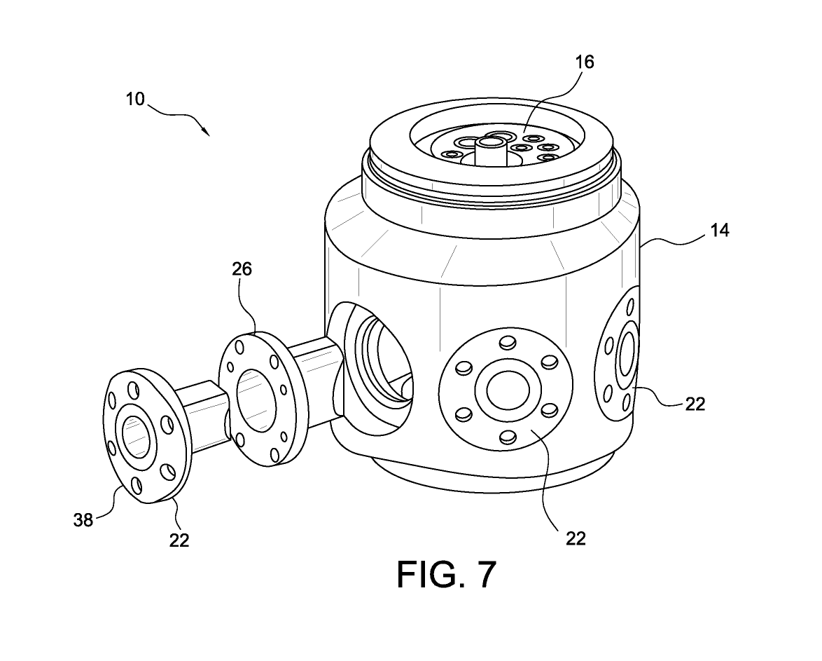

Turning in detail to the drawings, FIG. 1A schematically shows one configuration of a 360-degree panoramic camera system 10, which includes a camera module arrangement 12, a camera-housing module 14, an electronic interface 16, an imaging system 18, and an output interface/display 20. The camera module arrangement 12 includes a plurality of cameras positioned at angular intervals α around a central axis 24 (FIG. 1B) to capture images of objects in an environment E around a 360-degree field of view. The system 10 also preferably includes a plurality of camera-module receivers 26 (FIGS. 6-7), each of which are configured to at least partially house a camera module 22 and protect system elements contained within the camera housing module.

The 360-degree panoramic camera systems disclosed herein utilize technology that processes raw video streams of objects at a minimum of 24 frames per second. In so doing, these systems produce high-resolution (e.g. resolution ≧10⁶ pixels), seamless images of objects within the 360-degree field of view. The technology also allows for real-time correction of distortions, spherical projection, stitching, blending, white balance, etc. In addition, the technology provides increased resolution of images for improved picture fidelity, object recognition, facial recognition, and selection of regions/objects which are of viewing interest.

Camera Modules

FIG. 1B schematically shows how the camera module arrangement 12 may be radially positioned around a central axis 24. The camera module arrangement shown, however, should not be construed as limiting. Together, a plurality of camera modules should capture a 360-degree field of view.

Each camera module 22 captures a field of view F1, F2, F3, F4, F5, F6, F7, F8, as shown in FIG. 1B. Each of these fields of view overlaps in a common overlap area C1, C2, C3, C4, C5, C6, C7, C8 between two camera modules. Even a minimal common overlap area will allow the system to produce a final seamless image. Image output data streams D1, D2, D3, D4, D5, D6, D7, D8 (generally D) are captured by each camera module 22 in each field of view and transmitted to the electronic interface 16 via cable 28 (FIG. 1A) and then to the imaging system 18 via one or more communications links 19, as further described below.

Each camera module 22 generates an image output data stream D, which may be transported to the imaging system 18, using individual copper or fiber communications links, or multiplexed onto a fiber communication link and then transmitted to the imaging system 18, through the electronic interface 16. One preferred type of communication link is course wave division multiplexed (CWDM) single mode fiber, which allows for data transfer over cables up to several miles in length.

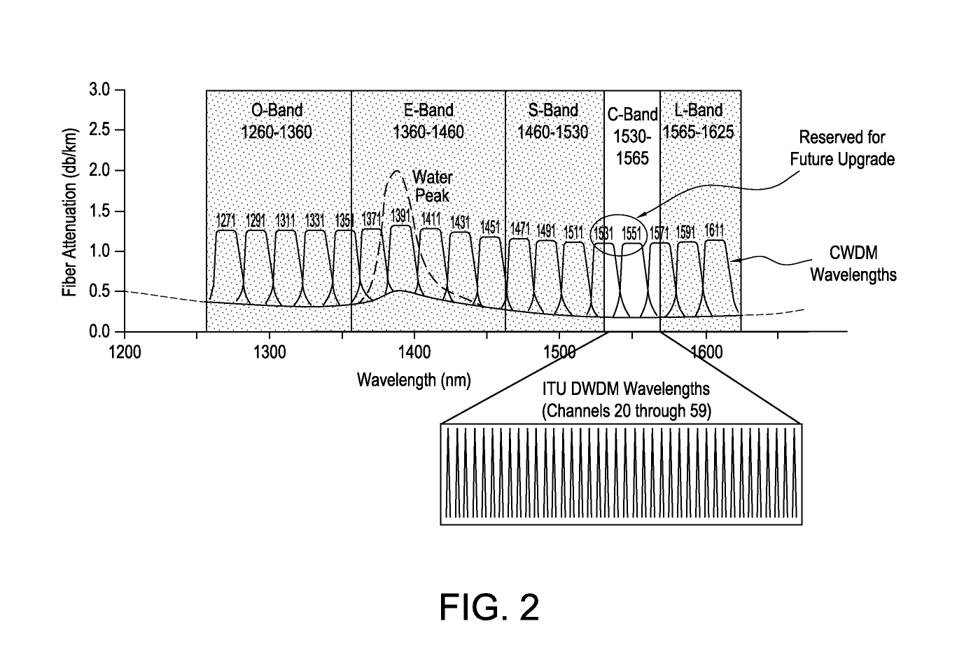

Each camera module uses a unique transmit and receive wavelength (color). For example, where the communication link is configured as a CWDM singe mode fiber and six camera modules are specified, each camera module uses 2 of 18 colors available to the CWDM. Six pairs of single mode fibers may therefore be used to feed a course wave division multiplexer, thereby combining the 12 colors onto a single fiber. FIG. 2 illustrates the relationship of fiber CWDM wavelengths. In one configuration, a CWDM fiber line is multiplexed and demultiplexed at each end by proprietary multiplexer/demultiplexer units.

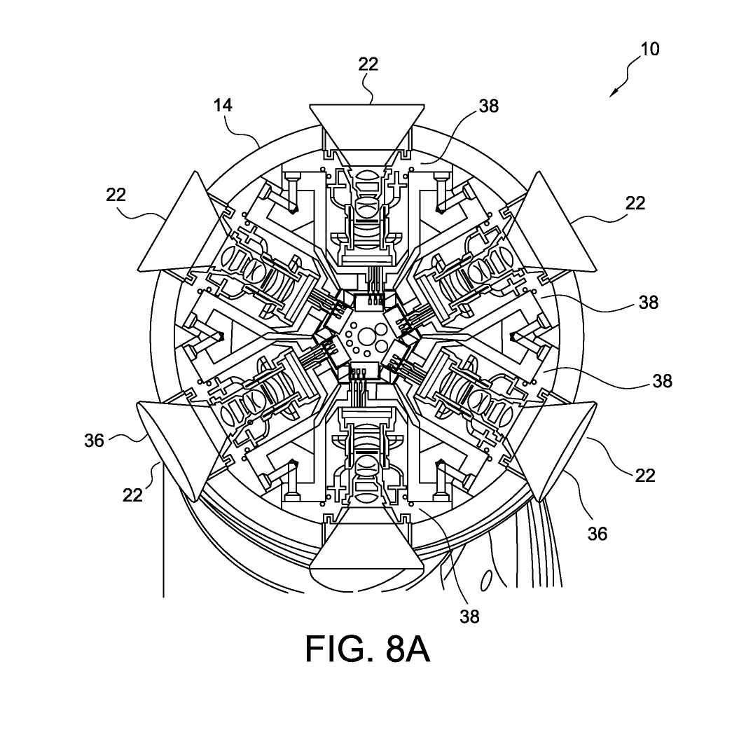

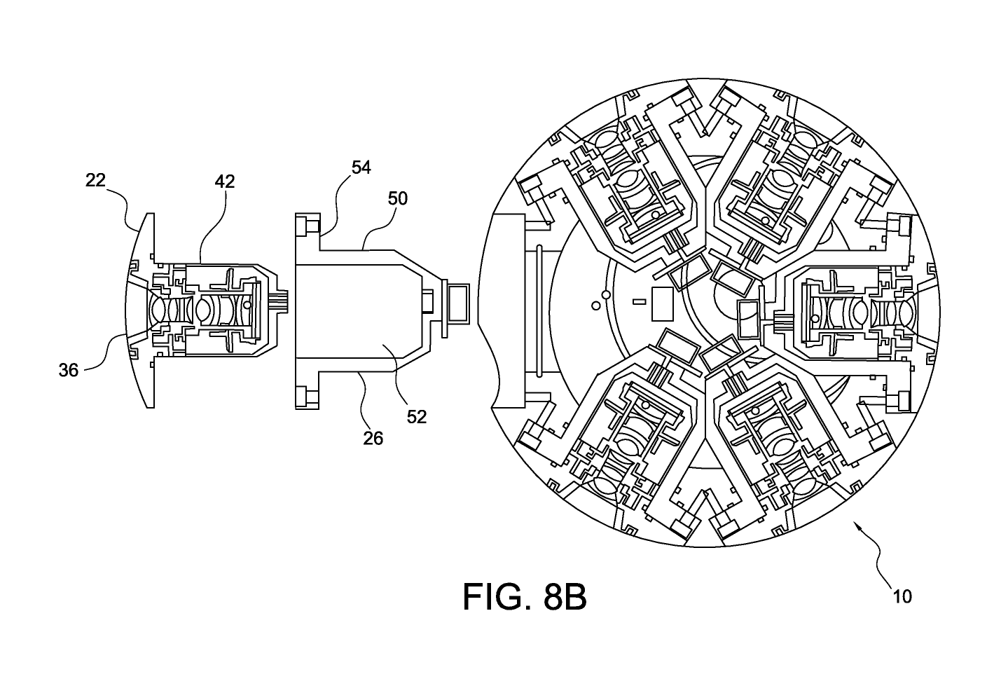

A camera module includes a lens 36 (FIG. 8A) positioned within a lens housing 38, an optional protective window (not shown) positioned over the lens, and one or more sensors contained within a camera module body 42. Each camera module 22 contains a high resolution sensor. These sensors may be configured with overlapping fields of view. Thus each camera module itself provides increased resolution.

Camera Receivers

Each camera module 22 is preferably configured for positioning within a camera-module receiver 26. Each camera-module receiver is designed to provide an environmental boundary, which prevents the infiltration of water, dirt, and other potential contaminants into the camera-housing module while also allowing access to the internal cabling for installation and servicing.

The camera-module receiver 26 also includes a serial communications adapter 27, preferably a small form printed circuit board containing, for instance, a copper-to-fiber converter. A camera-module receiver is also preferably configured to complement the shape of the camera module.

As such, a camera-module receiver can include an elongated outer shell 50 having an inner profile 52 that compliments the outer shape of the camera module body 42. The camera-module receiver 12 can also include an annular element 54 configured to sit flush against the backside of the lens housing 38 when the system is fully assembled (See FIGS. 7, 8A, and 8B).

Camera-Housing Module

The camera-housing module 14 is designed to maintain multiple boundaries to prevent environmental contamination of the system. The camera-housing module 14 includes a housing body 70, which includes a top aperture 72, a bottom aperture 74, and a plurality of side apertures 76.

The housing body 70 may have any configuration suitable for containing multiple system elements, including at least a partial containment of a camera module arrangement 12, a plurality of camera-module receivers 26, and an electronic interface 16. The top aperture 72 is of sufficient size and shape to position the electronic interface 16, while the plurality of side apertures are each of sufficient size and shape to position a camera module 22.

Preferably, the camera-housing module is manufactured from one or more weather- and corrosion resistant materials. Materials suitable for manufacture of the camera-housing module include, but are not limited to, stainless steel, galvanized steel, titanium, and composite materials. The overall design of the camera systems disclosed herein, including the camera and camera-housing designs, includes one or more elements that provide mechanical alignment and retention of 360-degree panoramic cameras modules. These elements can provide, for example, mechanical alignment and retention between adjacent cameras to allow (a) cameras to be aligned in the housing with minimal or no interaction with adjacent cameras, and (b) one camera to be replaced and realigned without affecting the alignment of other cameras. The mechanical alignment of separate 360-degree panoramic cameras thereby facilitates combining separate imagery to achieve image fusion in real-time. And, the results are displayed to enhance real time detection, tracking, and identification. These elements can, therefore, reduce or eliminate the need to compute for misalignment in real time.

Imaging System

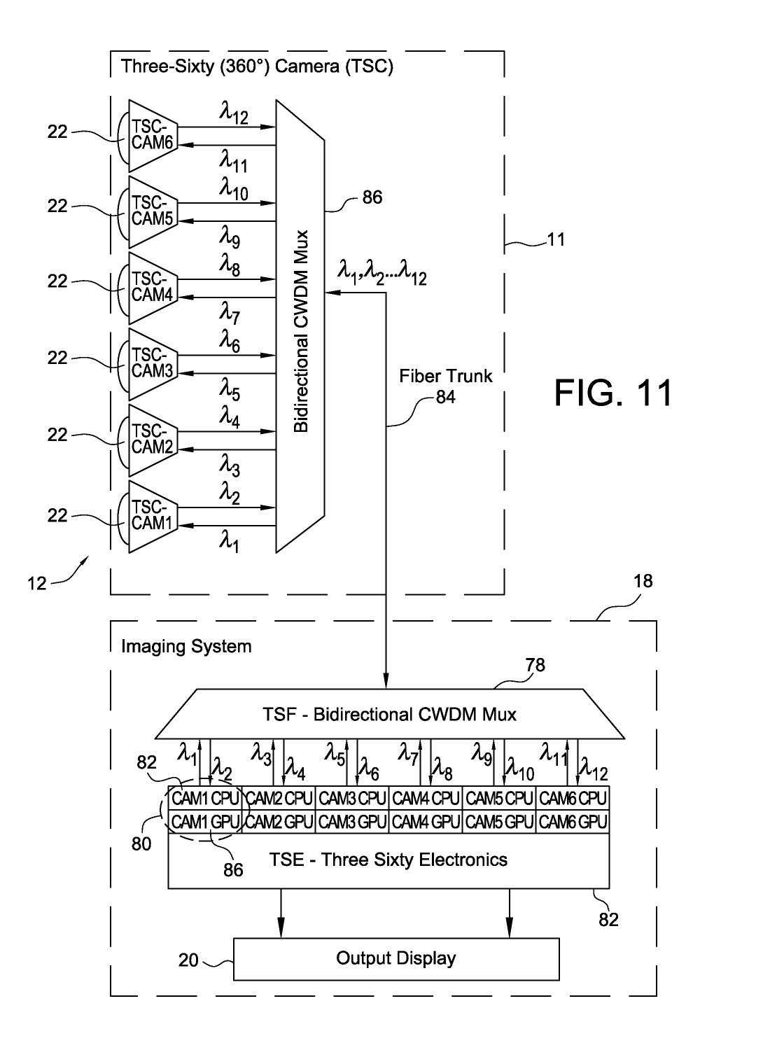

FIG. 11 is a schematic, illustrating one configuration of an imaging system 18 and how it is coupled to a three-sixty camera 11 by a fiber connection 84. The camera 11 includes a camera arrangement of six individual camera modules 22 in communication with a bidirectional CWDM Mux 86. The imaging system 18 is configured to process input from each camera module, remove distortion from a plurality of images received from the plurality of camera modules, and merge the respective images. In so doing, the imaging system creates a seamless image of objects in the 360-degree field of view, and supports dockside or at-sea camera repair without compromising the camera-housing module to environment effects (e.g. excessive moisture). The plurality of images used to create the seamless image could also be captured by a camera module arrangement 12 shown in FIG. 1B, for example.

The imaging system 18 is coupled to each camera module 22. The imaging system 18 includes a TSF—Bidirectional CWDM Mux 78, image processors 80, Three Sixty Electronics 82, and the output interface/display 20. Each image processor 80 (one example shown represented within dashed lines) is implemented with a multi-core Central Processing Unit (CPU) 82 and a Graphic Processing Unit (GPU) 86. Each image processor 80 is coupled to the output interface/display 20 to process image signals and generate signals representative of images captured by the camera modules. These signals are then transmitted to the output interface/display 20 for real time viewing and display of seamless panoramic images in the field of view around the camera module arrangement 12. Moreover, the image processors process real-time image data streams at a minimum of 24 frames per second.

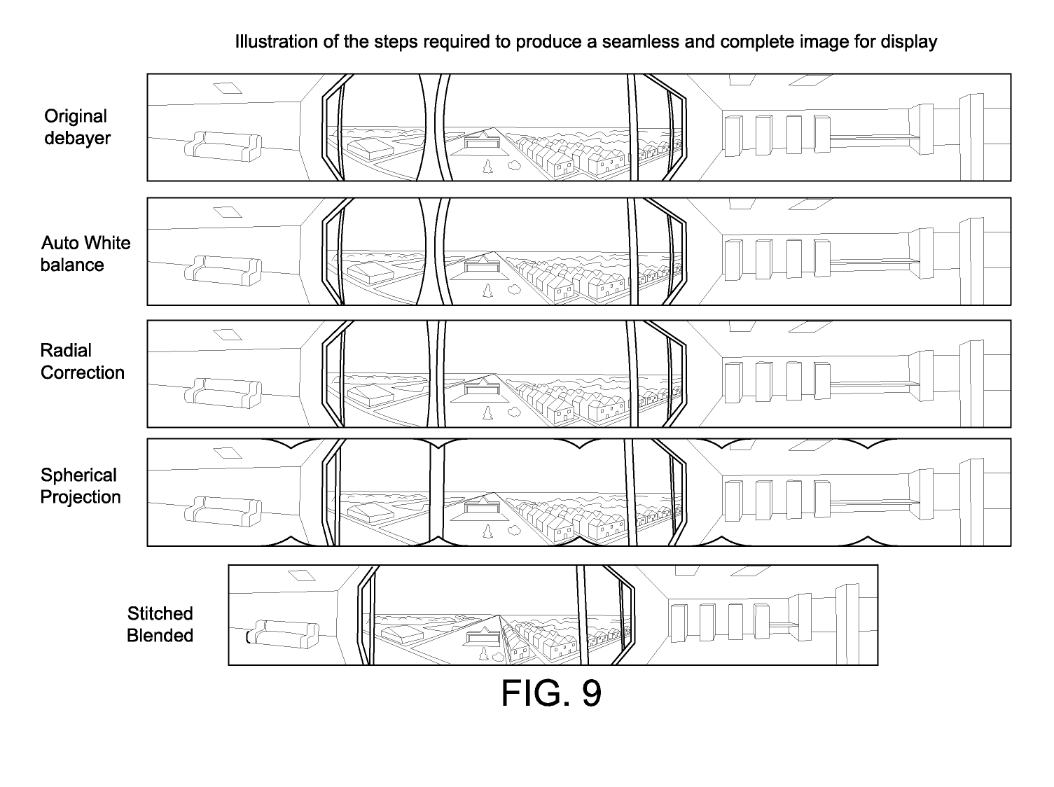

When the 360-degree panoramic camera system 10 is in use, an incoming image signal is first de-multiplexed from a fiber into multiple video streams. Then the resulting video/image streams are processed in real-time to produce a final image. FIG. 9 illustrates the following processes used in the system to create a final seamless image:

1. debayer (demosaic), to obtain a full color image

2. radial distortion correction, to straighten vertical lines

3. auto white balance, to produce proper color balanced images

4. spherical projection, convert 2D to 3D coordinates

5. stitching, required to mate the segments into a complete image

6. blending, to match surfaces, lines, colors, brightness, contrast to produce a seamless image.

The precision of the camera system is such that the distortion correction, spherical projection and stitching may be performed once during system installation without repetitive recalculating over time. This type of precision allows the images to be projected, translated, rotated, and stitched in real time without additional image analysis and/or adaption. The effect of this improvement is a significant reduction in requirements for processing power. The system also provides automatic adjustment of white balance and blending a reduced rate over time to account for changes in ambient light and scene. In addition, in some configurations of the system, cameras modules that cover the same or different spectral wavebands can be stacked; and precise alignment between them may be performed using software executed by the imaging system.

Processing Algorithms and Output Interface/Display

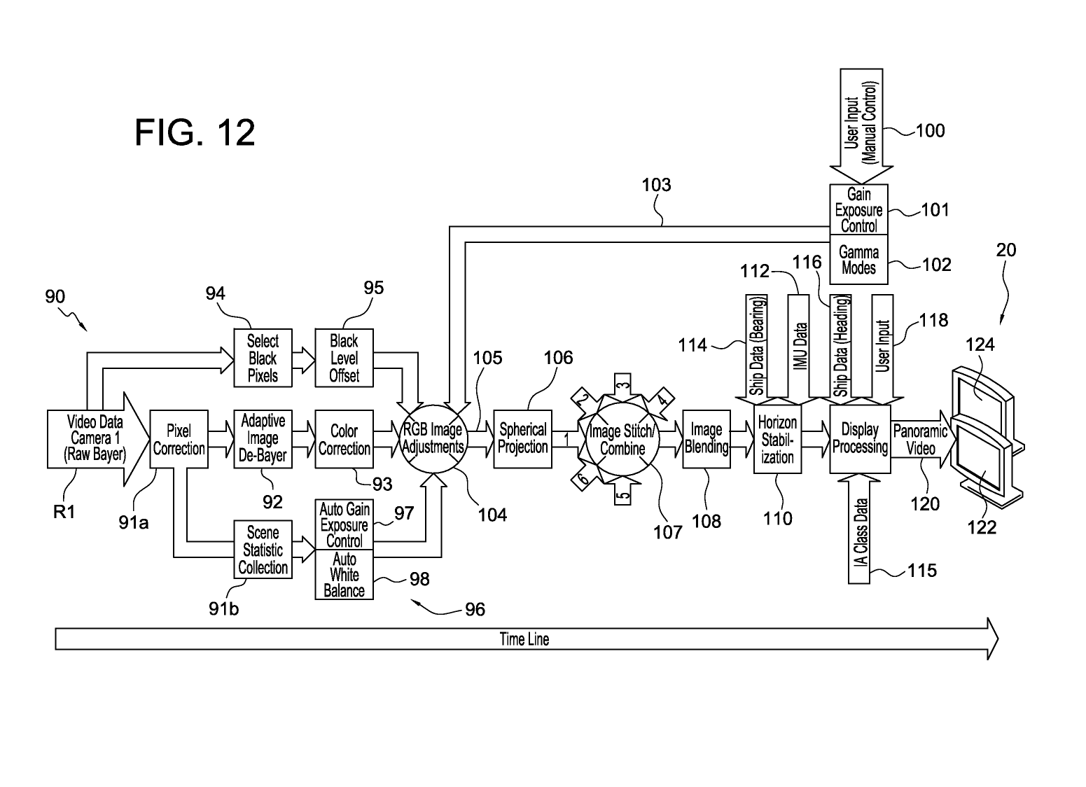

The 360-degree panoramic camera system 10 utilizes a processing algorithm to process image signals. The processing algorithm may be included in one or more software executable files encoded onto computer readable media of a data storage device for execution of the algorithm. A schematic depicting one type of processing algorithm 90, occurring over a specified time line 126, for a 360-degree panoramic camera system is shown in FIG. 12. The processing algorithm 90 uses known fixed relationships of the cameras to vertically and horizontally align images and blend images taken by each camera module.

According to one embodiment, the processing algorithm 90 processes raw video data R1 and performs steps of pixel correction 91a, image de-bayering 92, and color correction 93. From the raw video data R1, black pixels 94 are selected and a black level offset 95 is generated. From the pixel correction, the process algorithm also includes scene statistics collection 91b and image adjustments 96, which are calculated by auto gain/exposure control 97 and auto white balance 98 functions. User Input 100 by manual control, for example, is received and used by Gain Exposure Control 101 and Gamma Modes 102 for manual adjustment 103. Black level offset 95, image adjustments 96, and manual adjustment 103 are used to generate RGB image adjustments 104. The resulting image 105 is then projected onto a virtual surface; in this example, a spherical surface, by spherical projection 106. Then, the projected image is image stitched and combined 107 with projected images received from the other cameras (indicated by arrows labeled 2-6).

The step of image blending 108 is then performed to smooth the transitions between the received camera images. The step of horizontal stabilization 110 occurs by processing Inertial Measurement Unit (IMU) data 112 and optionally vehicle bearing data 114, resulting in adjustments for horizon positioning. Vessel/Ship bearing data 116, user input 118, and if required, data classification information (1A Class data) 115 may be used for final processing and alignment. The resulting panoramic video 120 is displayed on the output interface/display 20. As shown in FIG. 12, the output interface/display may be one or more monitors 122, 124 that are each coupled to the imaging system 20.

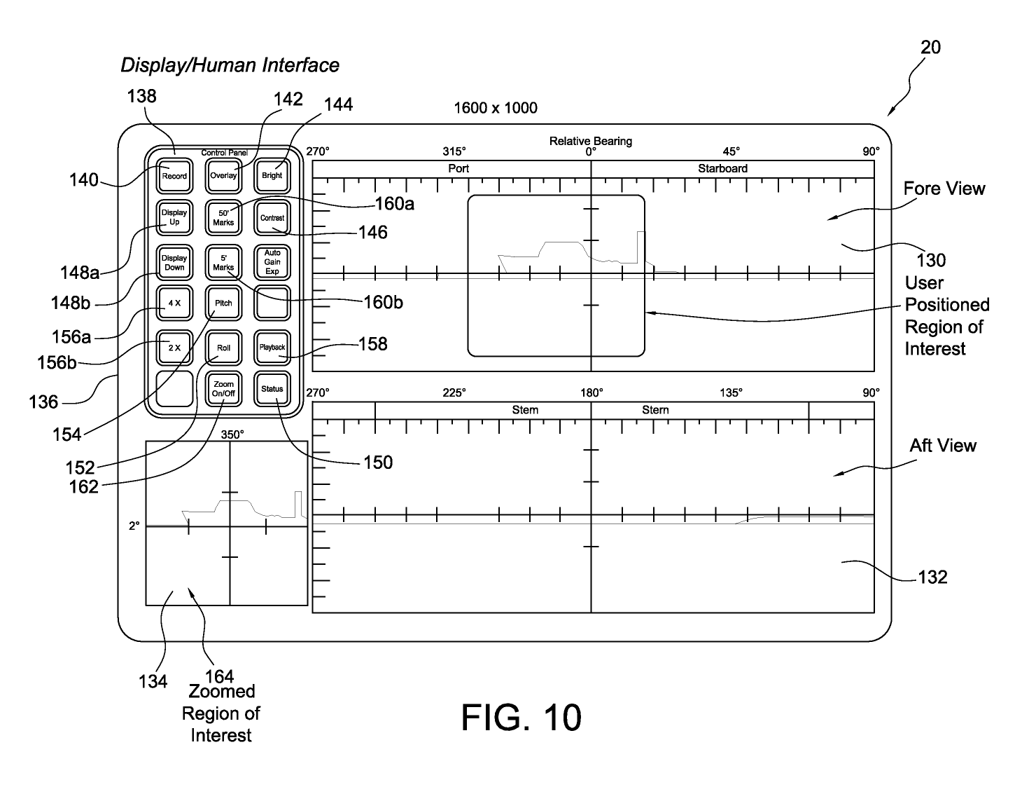

One example of an output interface/display 20, which may be displayed on a monitor, is shown in FIG. 10. This example presents panoramic images, which are received from the imaging system. These images may be shown as a fore (front) 180-degree view 130 and an aft (rear) 180-degree views 132 on the output interface/display 20. A window 134 on the lower left allows for a zoomed region of interest to be displayed. The output interface/display 20 is coupled to a control panel 136, which includes various control options. These control options may be controlled by a user via a touch screen 138 or mouse (not shown), for example. Options and controls include, but are not limited to, recording controls 140, overlap controls 142, brightness controls 144, contrast controls 146, display positioning controls 148a (Display Up), 148b (Display Down), status controls 150, roll controls 152, pitch controls 154, zoom magnification controls 156a (e.g. 4×), 156b (e.g. 2×), playback controls 158, marks controls 160a, 160b, zoom on/off controls 162. The zoom controls allow an operator of the system to add a positionable region of interest zoom box 164, which may be included in a zoom display section of the output interface/display 20.

Platforms for the 360-Degree Camera System

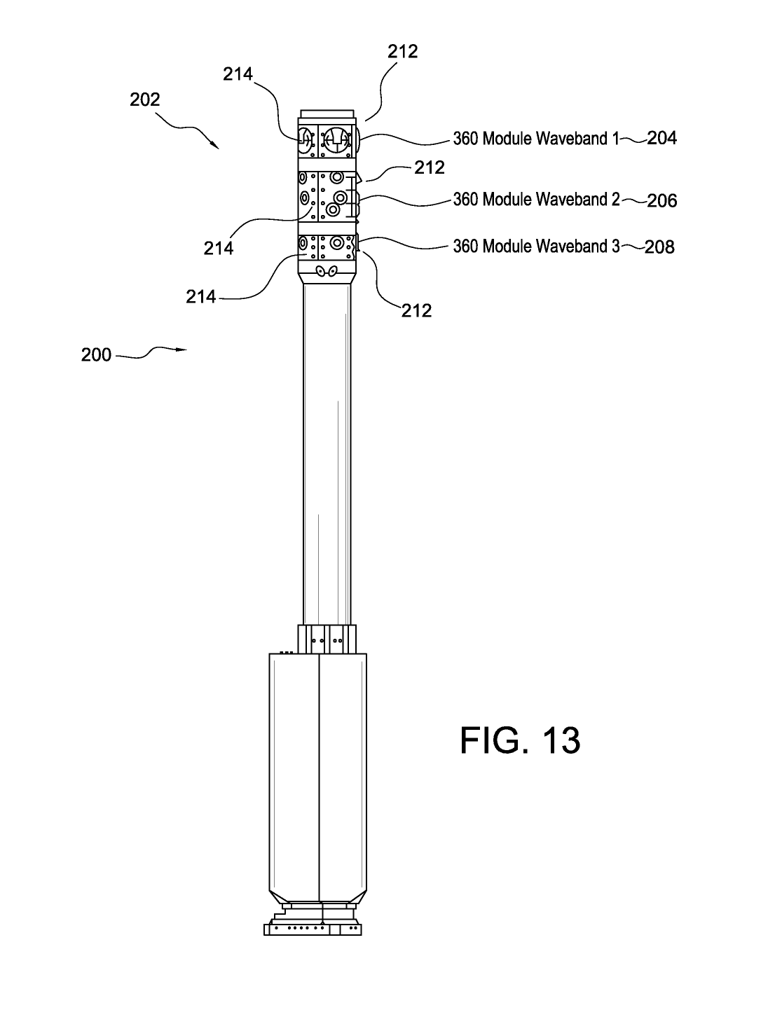

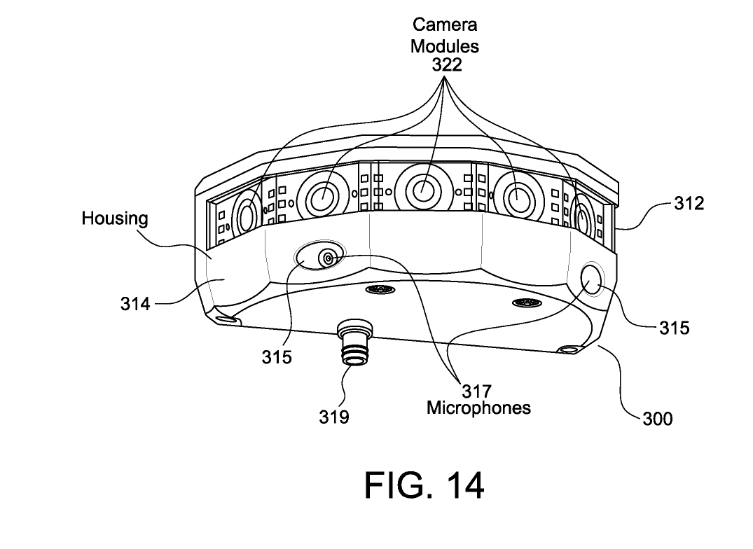

The 360-degree panoramic camera systems disclosed herein may be incorporated into any platform where situational awareness may be of use, including platforms requiring less than 360-degree view such as a surveillance system mounted to the side or corner of a building. Such platforms, include, but are not limited to vehicles, water-vessels, space vessels, ground based sensor platforms, and surveillance systems. Example platforms of a system include a mast 200 (FIG. 13) and a security system 300 (FIG. 14).

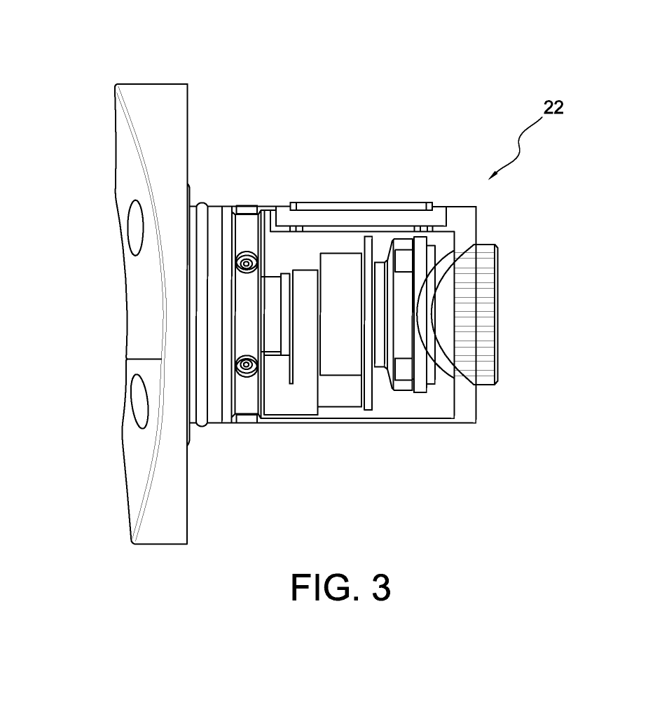

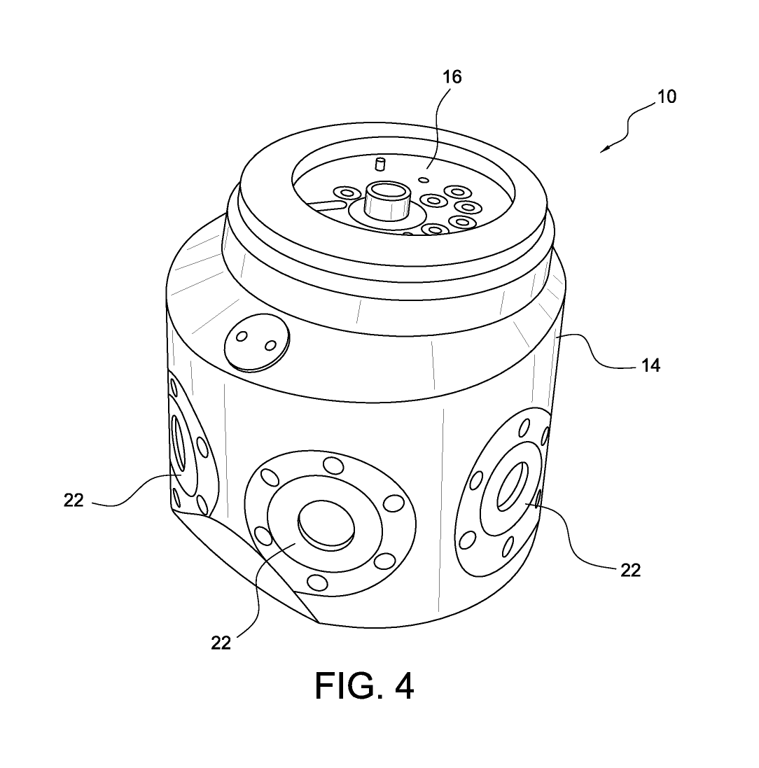

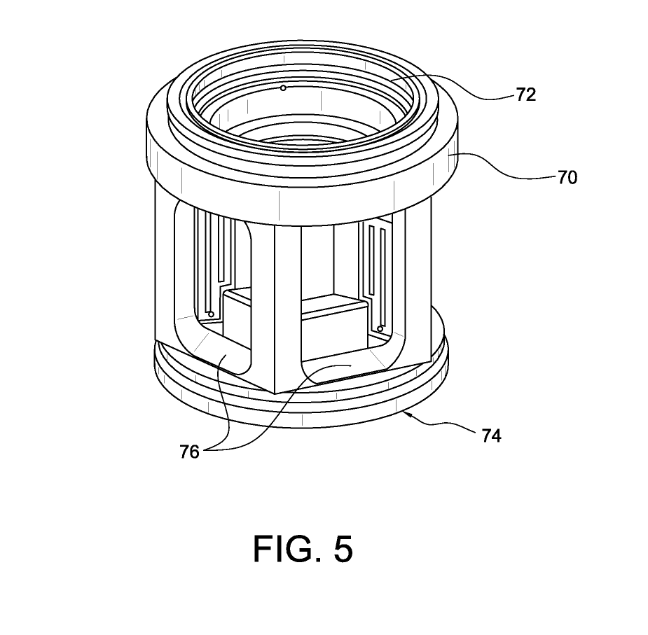

FIG. 13 shows an exemplary mast 200 that may be included in a water vessel, for example. This mast configuration includes a head 202 having a three camera systems 204. 206, 208 disposed therein. Each camera system is configured to operate in a unique waveband relative to the other camera systems. Each system also includes a camera module arrangement 212, a camera-housing module 214, an electronic interface (not shown), an imaging system (not shown), and an output interface/display (not shown). Each of these respective elements may be configured as described with respect to FIGS. 1A-8B.

FIG. 14 shows an exemplary security camera system 300 that includes a camera modules arrangement 312, having six camera modules 322. The arrangement is positioned within a security type camera-housing 314 and configured to capture images around about a 180-degree field of view. The camera-housing includes cavities 315 that house microphones 317 and at least one coupling element 319 used to attach the system to the corner of a building for example.

Each of these respective elements of the system 300 may be configured as described with respect to FIGS. 1A-8B, but where the captured field of view generally ranges from 180°to 360°.

While embodiments of this invention have been shown and described, it will be apparent to those skilled in the art that many more modifications are possible without departing from the inventive concepts herein. The invention, therefore, is not to be restricted, except in the spirit of the following claims.

1. A 360-degree panoramic camera system, comprising:
a plurality of camera modules positioned at angular intervals with respect to a central axis to capture images around a 360-degree field of view,
a camera-housing module configured to at least partially house each camera module, and
an imaging system coupled to each camera module.

2. The 360-degree panoramic camera system of claim 1, wherein the imaging system comprises one or more image processors that process real-time image data streams at a minimum of 24 frames per second.

3. The 360-degree panoramic camera system of claim 1, wherein the imaging system produces a high-resolution and seamless image of objects positioned within the 360-degree field of view.

4. The 360-degree panoramic camera system of claim 1, wherein the imaging system is configured to correct image distortion, spherical projection, stitching, blending, and white balance in real-time.

5. The 360-degree panoramic camera system of claim 1, further comprising an output interface/display electrically coupled to the imaging system.

6. The 360-degree panoramic camera system of claim 1, wherein the imaging system is configured to support camera repair without compromising the camera-housing module to environmental effects.

7. The 360-degree panoramic camera system of claim 1, wherein each camera modules comprises one or more low-resolution sensors.

8. The 360-degree panoramic camera system of claim 1, wherein each camera module comprises one or more high-resolution sensors.
